(19) United States
(12) Patent Application Publication
(10) Pub. No.: US 2007/0266990 A1
(43) Pub. Date: Nov. 22, 2007

(54) Variable compression engine

(76) Inventor: John T. Sims, Bainbridge, GA (US)

Correspondence Address: John Wiley Horton, 215 South Monroe Street, 2nd Floor, Tallahassee, FL, 32301, US

(21) Appl. No.: 11/434,699

(22) Filed: May 16, 2006

(51) Int. Cl. F02D 13/04; F02B 75/04; F01L 9/02; F02B 75/02

(52) U.S. Cl. 123/321; 123/316; 123/90.12; 123/78 R

(57) ABSTRACT

A variable compression engine has a relief valve disposed in the combustion chamber thereof to reduce compression. The relief valve is open for a portion of the compression stroke of the engine. The open relief valve permits a portion of the fuel/air mixture introduced via the intake valve to leave the combustion chamber and return to the fuel supply or intake manifold via a check valve that prevent flow into the combustion chamber through the relief valve. Timing of the opening and closing of the relief valve is selectable via a cam-operated hydraulically operated by a camshaft rotating once for every two revolutions of the engine's crankshaft, or timing of opening and closing may be achieved by other suitable mechanisms. Additionally, the height of lift of the relief valve can be varied to further adjust compression around a selected relief valve opening point.

### TECHNICAL FIELD

The present invention relates generally to combustion engines, and more specifically to a variable compression engine, wherein compression within the combustion chamber is reduced during the compression stroke by opening a relief valve.

### BACKGROUND OF THE INVENTION

The cost of petroleum fuels, environmental concerns, and fuel supply consistency from politically unstable regions of the world, all cause concern for the viability of gasoline-based fuels. Further, as oil resources dwindle world-wide and demand for oil increases, particularly in developing counties, efforts to utilize other energy resources increase.

Accordingly, more and more countries are turning to alternative fuel sources wherever possible. For example, Brazil (the largest ethanol producer in the world) has substantially converted its vehicle fleet to ethyl alcohol (ethanol) as a fuel stock. Since the United States is the second largest ethanol producer in the world, ready fuel stocks exist for supplying America's vehicular fleet.

Alternative fuels such as ethanol have the further benefit of reducing the generation of NOₓ compounds, thereby effectively improving air quality. Furthermore, since oil-based compounds, such as gasoline, contaminate soils and water, whereas ethanol readily disperses and evaporates from water, improvements to soil and water quality are also achievable through use of alcohol-based fuels.

However, in spite of the benefits, such alternative fuels are not readily introduced into the market due to a lack of equipment that can utilize them efficiently and/or a lack of infrastructure to provide them. Further compounding the problem is that an engine designed for one type of fuel is not adaptable to utilize a different fuel without great difficulty.

While there are “selective fuel vehicles” available today, and they offer limited ability to utilize alcohols as fuel, they do not improve the combustion process for alcohol, they merely add more fuel (typically by altering the fuel injector timing) to compensate for the lower energy level of alcohols, and, thus, the alcohol fuels are utilized very inefficiently. Moreover, this reduced efficiency offsets the cost reductions that would otherwise be achieved, and aggravates air, water and soil pollution. Thus, rapid conversion to alcohol fuels is highly desirable.

In order to gain market acceptance for a selective fuel vehicle, the vehicle must provide the user with confidence that it can be fueled while travelling away from its home base. Unfortunately, existing vehicles are limited to use of individual fuels, or use of fuels that are only slight variations of each another, or alternately are inefficient and/or require modifications to run on alternative fuels. For instance, gasoline fuel stations are ubiquitous and the consumer has high confidence that he/she will be able to obtain fuel wherever he/she goes. However, alternative renewable fuels, such as ethanol, lack such infrastructure. Thus, a driver will not purchase a vehicle to run on ethanol if he/she does not know for certain that he/she will be able to obtain ethanol while out and about. On the other hand, if a driver can purchase a vehicle that will run on gasoline or on ethanol without conversion, and without any burden placed on the driver to make any changes, such a driver will willingly select a variable fuel vehicle with confidence.

As ethanol stations slowly increase their presence, drivers will slowly gain the confidence to purchase ethanol fueled vehicles. However, if they have the confidence that they can utilize gasoline or ethanol whenever they find either such station, drivers will rapidly select such adaptable vehicles and the change over to ethanol fuels will be more rapidly achieved.

In order to provide for such consumer confidence, vehicle engines must be capable of operating on a variety of fuels. However, this has not heretofore been the norm.

For instance, internal combustion engines are typically designed to operate on a single specific quality and type of fuel, most commonly gasoline at approximately 87 octane rating. As alternative fuels enter the market, engines must be designed to accommodate them. However, different fuels, or different qualities of a specific fuel, vary in their energy content (as expressed by octane rating), and, thus, require optimum conditions for the release of the energy contained therein. To adapt to different fuels and provide optimum efficiency therefrom, the compression within the engine must be changed.

For instance, gasoline fuel engines typically are designed within a range of 7-9 to 1 compression ratio, while ethanol based fuels advantageously utilize a 15-17 to 1 compression ratio. Unfortunately, while engines may be designed to run on ethanol, or mixtures of gasoline and ethanol, current efforts merely design to a new fixed compression and are not directed to attaining an increased efficiency through variability of compression. When changing between fuels, such previous designs have typically merely add more ethanol to make up for ethanol's lower energy content.

Typically, an internal combustion engine compresses the fuel/air mixture prior to ignition thereof. Most commonly, the Otto cycle is utilized, comprising four strokes: 1) Intake of fuel (intake stroke) through an intake valve, during which the piston moves in its cylinder away from the combustion chamber thereby increasing the volume above the piston and drawing a vacuum which pulls fuel/air in through an intake valve; 2) compression of the fuel (compression stroke), during which the piston moves in its cylinder towards the combustion chamber reducing the space above the piston; 3) combustion of the fuel (power stroke), during which expanding ignited gases move the piston away from the combustion chamber; and 4) exhaust of the burned fuel/air (exhaust stroke), during which the piston moves again towards the combustion chamber, while venting spent gases through the exhaust valve. Thus, each full Otto cycle comprises two rotations of the crankshaft of the engine to accomplish the four strokes.

Ignition typically takes place slightly before the piston reaches top dead center (TDC) of the compression stroke. If the fuel/air mixture is too hot (from too much compression), an auto-ignition or pre-detonation (knock) may occur that is both detrimental physically to the structure of the engine, and further results in a loss of efficiency. Thus, selection of a correct compression is imperative for improved life and efficiency. However, in order to utilize a variety of fuels to their maximum efficiency and requiring different compressions, an engine must be designed for the maximum compression ratio fuel with reduction of compression from the maximum level as required by lower compression fuels.

Other internal combustion cycles may also require appropriate selection of compression for optimum efficiency. For instance, the four strokes may be combined into two. In a two-cycle engine (two-stroke engine), the intake and compression strokes are combined into one, with intake of fuel in the early part of the first stroke, followed by compression once the intake valve is closed. Subsequently, the fuel is ignited and then exhausted in the last portion of the combustion or power stroke. Again, as for the four-stroke engine, variability of compression will permit the use of varying fuels.

While a type of four-stroke engine, a Miller cycle engine has a similarity to a two-cycle engine in that the compression stroke of the Miller cycle includes a beginning period (sometimes considered as a fifth stroke) during which the intake valve remains open until extra fuel is pushed back out through the intake valve rather than being compressed, thereby reducing the fuel/air load. Once the intake valve closes, compression begins, but is accordingly lessened by the period during which the intake valve was open. This reduces the compression and, accordingly, the temperature of the fuel/air mix at ignition, resulting in reduced likelihood of “knocking”. This ultimately permits a higher design compression for Miller cycle engines. Unfortunately, the Miller cycle typically disadvantageously requires a supercharger to facilitate the introduction of air into the cylinder through the intake valve.

In addition to the above engine cycles, the Diesel cycle is commonly utilized for internal combustion engines. In the Diesel cycle, air that has entered the cylinder is compressed generating heat. This is followed by introduction of fuel when the piston is approximately at TDC, wherein the fuel is subsequently ignited from the heat, producing power to drive the piston downward. (Some Diesel engines may have an ignition source that retains incandescence to facilitate in the ignition of the fuel, particularly when starting.)

Diesel engines are typically designed with a fixed compression ratio that is optimum to a continuous level of power output. Alternately, Diesel engines may have compression varied by adjustment of a plate at the top of the cylinder, wherein placement of the plate closer to the piston results in higher compression, while removing the plate farther from the piston results in lower compression. Thus, variations in fuel quality can be overcome by adjustment of an optimum compression for the particular fuel in use. Unfortunately, Diesel fuels are also typically derived from oil resources, and, thus, do not alleviate the problem of short supplies of oil.

For all of the above types of engines, fuel and/or air are provided to the combustion chamber through an intake valve that opens during a portion of the intake stroke. Subsequent to combustion of the fuel/air mixture, spent fuel/air is removed through an exhaust valve that is open during a portion of the exhaust stroke. During the compression and power strokes, both the intake and exhaust valves typically remain closed, although as noted hereinbelow (and for the Miller cycle engine as described hereinabove), the intake valve may be open for a portion of the compression stroke.

During compression, as the piston extends itself within the engine cylinder, it compresses the fuel/air mixture to a selected level of compression based on a design compression ratio that is determined by the size of the combustion chamber as it varies from full retraction of the piston to full extension of the piston. Consequently, as the piston withdraws from within the cylinder, compression is reduced and vice versa. Near peak compression, the fuel/air mixture is ignited and combustion takes place providing power to the engine. While a modicum of variability of compression can be obtained by selection of the timing of firing of the igniter device, such timing can only offer a limited selectivity of the compression. Such limitation typically prevents the use of alternative fuels within an engine unless mechanical modifications are made thereto to provide different compression ratios. Such mechanical modifications are generally extensive and costly.

Accordingly, various methods have been utilized to alter compression of an operating engine. For instance, timing the opening of the intake valve to control fuel/air mass will selectively reduce or increase fuel/air mass, resulting in reduced/increased compression. Further, varying piston stroke length, such as via altering the length of a connecting rod through varying oil pressure from lubrication system, and/or via varying lift and angle of intake valve, may be utilized to vary compression. However, such an approach utilizes discrete levels of compression and precludes continuous variation.

Overlapping the opening and closing of intake and exhaust valves may be utilized to adjust compression. Varying the valve overlap period to change the fuel/air mix will increase or decrease the density of the fuel/air mix, will also result in increased or decreased compression. However, such overlap (both valves open at the same time) will cause newly introduced fuel to pass out through the exhaust and consequently be wasted.

In yet another approach, two-part pistons have been utilized, with or without upper and lower chambers, wherein the pistons vary in size by application of oil pressure channeled through crank and rods, the pistons having valves in the connecting rods, wherein the valves effectively vary the volume of the combustion chamber. Again, such an approach can only select between discrete intervals of compression and cannot be externally varied.

As a result of design constraints, such previous devices are limited to selection among fixed ratios of compression and/or rely upon the entry and variation of fuel and/or air admitted to the combustion chamber before the compression portion of the cycle begins. Thus, previous devices have lacked variation of compression during the compression stroke itself, and further lack the ability to vary the compression ratio by external means. Due to their lack of variability, such engines are not readily adaptable to changes in fuels or fuel quality. This acts as a deterrent to the acceptance of alternative fuel vehicles, since the user cannot fuel with gasoline one day, then drive out of town and fuel with ethanol the next day.

Therefore, it is readily apparent that there is a need for an internal combustion engine having a variable compression that can be readily adjusted without modification and/or disassembly of the engine, to allow the ability to automatically adapt for alternative fuel stocks.

### BRIEF SUMMARY OF THE INVENTION

Briefly described, in a preferred embodiment, the present invention overcomes the above-mentioned disadvantages and meets the recognized need for such a device by providing a variable compression internal combustion engine having a compression that is variable via a relief valve (in addition to the intake and exhaust valves) that is precisely timed and controlled by a selectable timing hydraulic pump designed to relieve compression in the combustion chamber during the compression stroke of an engine. This third valve is timed via an external mechanism comprising a hydraulic mechanism on a movable, indexable, or rotatable plate, thereby varying the compression so that the engine can easily and quickly be adapted to run on a variety of fuels.

The purpose of variable compression is to maximize the efficiency of the engine and to be able to accommodate other fuels such as diesel, ethyl alcohol, which are more efficient at higher compressions or to be able to use regular unleaded gasoline, which is not efficient and normally pre-ignites at high compressions. By permitting variation of the compression, a variety of fuels can be utilized in a single design engine and the engine may be readily switched between gasoline, natural gas, hydrogen, alcohol, Diesel fuel, or any mixture thereof.

The engine can be designed to a maximum compression ratio required for the highest compression fuel and the compression is reduced through removal of fuel, air, and/or fuel/air mixture during the compression stroke. The fuel exiting the third valve is returned to the fuel feed system and/or intake manifold, and is thus fully recovered without loss.

According to its major aspects and broadly stated, the present invention in its preferred form is a variable compression engine, wherein a variable compression relief valve is opened during a portion of the compression stroke of an engine to relieve compression in the combustion chamber. Gases vented through the variable compression relief valve pass through ports in the valve stem, then on to the fuel supply or intake manifold via check valves. The check valves serve to prevent backflow of air into the combustion chamber through the variable compression relief valve.

Timing of opening and closing of the variable compression relief valve can be externally timed and/or controlled. It is actuated via timed hydraulic pressure, such as, for exemplary purposes only, via a hydraulic pump driven by a cam operating from a camshaft that turns one rotation for each two rotations of the engine crankshaft. The timing can be adjusted to overlap the closing point of the intake valve to selectively achieve the desired compression level, and, thus, utilize a variety of fuels in a single engine. The relief valve is hydraulically opened and closed by a hydraulic pump controlled by a mechanical or electrical mechanism that selects timing of the opening of the relief valve during a portion of said compression stroke.

The intake valve of the engine may remain open for a portion of the compression stroke and be open at the same time as the relief valve; however, the relief valve closes coincident with, or after, the intake valve closes. The compression may thus be varied as desired during running of the engine, or the relief valve closing point may be selectively set and fixed. Compression may then be further varied by adjusting the lift height and, thus, timing of closing point of the relief valve.

More specifically, the present invention is a variable compression engine comprising compensation for a wide variety of fuels by construction of the engine to afford a high compression and then providing a mechanism for reducing the compression as required. Variable compression is achieved by the use of a third valve located in the combustion chamber. The valve is opened (timed) at the beginning of the compression stroke to release the desired amount of pressure. The valve is actuated by hydraulic pressure from a hydraulic pump that is timed mechanically or electrically.

For instance, a small hydraulic (ram) cylinder is mounted on the variable compression relief valve. A small hydraulic piston pump riding on a cam operates the hydraulic cylinder and subsequently the variable compression relief valve. The opening height and duration of opening of the variable compression relief valve is selected for the particular engine. The cam is located on the existing engine camshaft or any shaft that turns at one-half the speed of the engine. A cam lobe pushes the pump piston, forcing fluid through a hydraulic line to the hydraulic (ram) piston that controls the variable compression relief valve, thereby opening the variable compression relief valve.

To alter the variable compression relief valve timing in relation to the piston/crankshaft, the pump is moved to alter the relief valve timing relative to the piston and existing valve timing. For example, the pump is mounted on a plate that is concentric with the camshaft. As the plate is rotated clockwise (CW) or counter-clockwise (CCW), the timing of the variable compression relief valve can be advanced or retarded in relation to piston travel. Rotation of the pump plate may be achieved via any suitable means, such as, for exemplary purposes only, the use of a solenoid or mechanical actuator.

When raising or lowering the compression via solenoid actuation of the hydraulic pump plate, the solenoid receives input from the oxygen (O₂) sensor, manifold absolute pressure (MAP) sensor, and/or anti-knock sensor. Additionally, other sensors utilize to optimize engine performance and efficiency, such as, for exemplary purposes only, sensors that send control signals to fuel injectors to increase fuel supplied to the engine, can also be utilized to control compression via the relief valve. In addition, a fuel sensor located in the fuel storage tank or the fuel delivery line senses the type of fuel and sends control signals to the timing mechanism controlling the relief valve.

In addition to moving the pump plate, a solenoid can be incorporated in the pressure line to dump the hydraulic pressure to the variable compression relief valve to retain maximum design compression if variable compression is not needed. Further, the timing plate can be rotated to a point where the variable compression relief valve closes before the intake valve closes for net effect thus maintaining maximum compression. Check valves are disposed in the gas/vent lines from the variable compression relief valves to prevent backflow of unfueled air from the intake manifold when the variable compression relief valve is open during a portion of the intake stroke.

In operation, as the piston reaches bottom dead center (BDC) the cam lobe will just be starting to apply pressure on the piston pump, which will, (via hydraulic line) open the variable compression relief valve. As the piston starts its compression stroke the variable compression relief valve will be held open for a given time to allow the escape of air/fuel mixture which if not vented, would result in a higher compression (pressure). The vented gas is subsequently routed back into the intake to be burned in later cycles. Once the relief valve is closed, compression will take place.

Thus, the variable compression permits a wide variety of fuels to be utilized in a single design engine with the ability to switch between fuels merely by variation of timing of the opening of the variable compression relief valve. Such variation is readily accomplished from an external location on the engine without the need for engine modification.

Accordingly, a feature and advantage of the present invention is its ability to adjust compression within the combustion chamber of an internal combustion engine.

Another feature and advantage of the present invention is its ability to permit an internal combustion engine to selectively utilize different fuels.

Still another feature and advantage of the present invention is its ability to obtain optimum energy release from fuels having differing compression requirements.

Yet another feature and advantage of the present invention is its ability to vary compression in response to a variety of sensors and combinations thereof.

Yet still another feature and advantage of the present invention is its ability to reduce the maximum compression within an internal combustion engine.

A further feature and advantage of the present invention is its ability to recover fuel vented from the combustion chamber during the compression stroke of an internal combustion engine.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1A is a perspective view of a variable compression engine according to a preferred embodiment of the present invention;

FIG. 1B is a detail side view of the engine of FIG. 1A, showing a valve timing pump mechanism of a variable compression engine according to a preferred embodiment of the present invention;

FIG. 2 is a cutaway side view of a combustion chamber, variable compression relief valve and timing pump mechanism of a variable compression engine according to a preferred embodiment of the present invention;

FIG. 3 is a detail cross-sectional view of a variable compression relief valve actuator of a variable compression engine according to a preferred embodiment of the present invention; and

FIG. 4 is a side view of a valve height adjustment mechanism according to an alternate embodiment of the present invention.

### DETAILED DESCRIPTION OF THE PREFERRED AND SELECTED ALTERNATIVE EMBODIMENTS

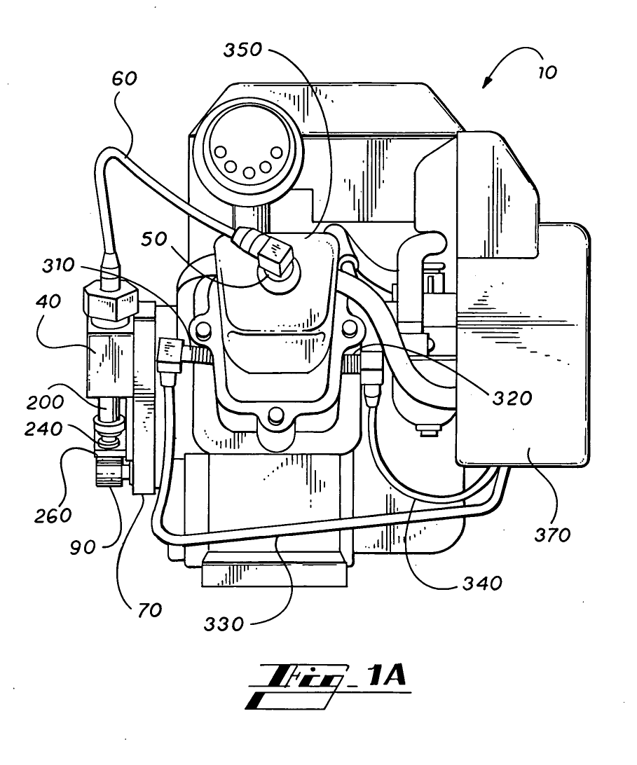

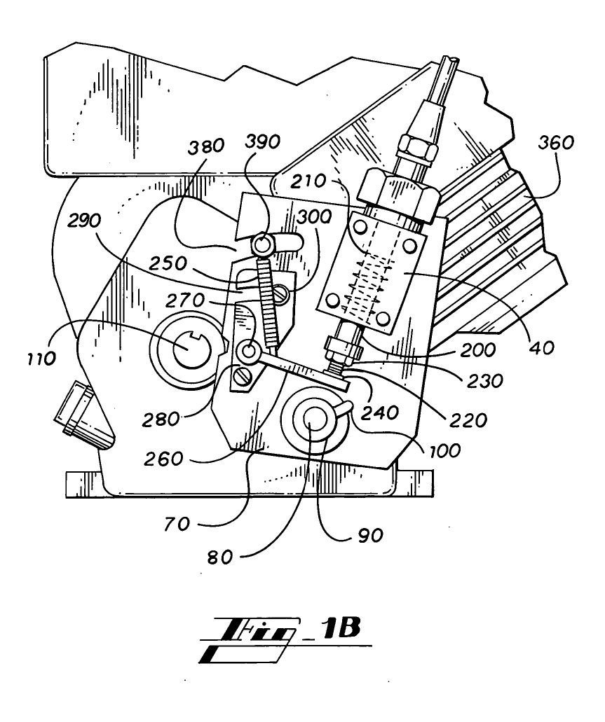

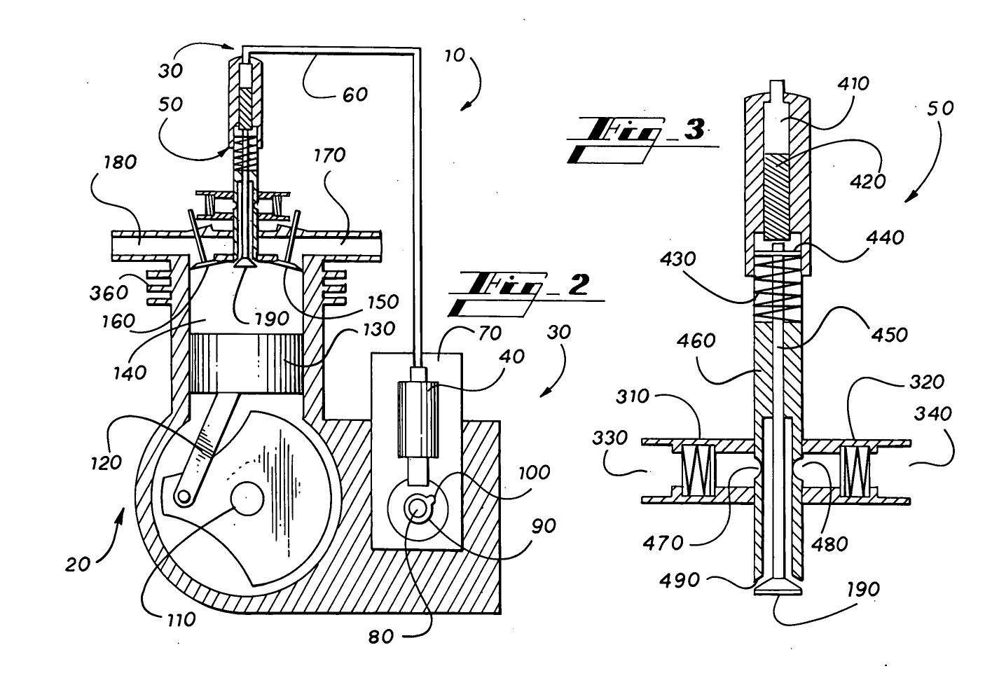

In describing the preferred and selected alternate embodiments of the present invention, as illustrated in FIGS. 1A-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1A-3, the present invention in a preferred embodiment is variable compression engine 10, wherein engine 10 preferably comprises motor 20 and compression relief valve system 30. Motor 20 preferably comprises crankshaft 110, connecting rod, 120, piston 130, combustion chamber 140, valve cover 350, head 360 and camshaft 80, wherein camshaft 80 preferably comprises cam 90 disposed thereon, and wherein cam 90 preferably comprises cam lobe 100. Head 360 preferably comprises compression relief valve 190, relief valve seat 490, intake 170 and exhaust 180, wherein intake 170 and exhaust 180 respectively preferably comprise intake valve 150 and exhaust valve 160.

Compression relief valve system 30 preferably comprises hydraulic pump 40, hydraulic valve actuator 50 hydraulic fluid line 60 and timing adjustment and pump support plate 70, wherein hydraulic valve actuator 50 and hydraulic pump 40 are preferably in fluid communication via hydraulic fluid line 60.

Hydraulic valve actuator 50 preferably comprises first check valve 310, second check valve 320, first return line 330, second return line 340, hydraulic cylinder 410, hydraulic ram 420, relief valve spring 430, relief valve spring retainer 440, relief valve stem 450, relief valve guide 460, first venting port 470 and second venting port 480.

Pump support plate 70 preferably comprises timing adjustment slot 380, wherein timing adjustment slot 380 preferably permits movement of pump support plate 70, and movement of pump support plate 70 concentrically around camshaft 80 selectively controls the opening point of valve 190. Timing adjustment locking mechanism 390 preferably secures pump support plate 70, while preferably permitting pump support plate 70 to be moved and subsequently locked into a selected timing position. It will be recognized by those skilled in the art that any means of providing rotation of pump might be utilized.

Hydraulic pump 40 preferably comprises piston 200, spring 210, adjusting screw 220, locknut 230 and pad 240, wherein adjusting screw 220 preferably permits extension or retraction of pad 240, and wherein adjusting screw 220 is preferably secured in position via locknut 230, and wherein spring 210 preferably biases piston 200 into extension.

Cam follower plate 260 is preferably disposed on cam follower securing/locking mechanism 270, wherein tensioning spring 250 is preferably connected between cam follower plate 260 and timing adjustment locking mechanism 390, wherein tensioning spring 250 preferably biases cam follower plate to contact pad 240 of hydraulic pump 40.

In an alternate embodiment of the present invention, pump support plate 70 preferably has disposed thereon fine timing adjustment plate 280, wherein fine timing adjustment plate 280 preferably comprises fine adjustment slot 290. Fine timing locking mechanism 300 preferably comprises fine adjustment slot 290, wherein height adjustment slot 290 preferably permits movement of fine timing adjustment plate 280. Fine timing locking mechanism 300 preferably secures fine timing adjustment plate 280, while preferably permitting fine timing adjustment plate 280 to be moved and subsequently locked into a selected position. In this fashion, the profile of the timing diagram and/or the lift of relief valve 190 can be altered, such that relief valve 190 can be controlled to snap shut, or to remain open through a selected angle of rotation of crankshaft 110.

In operation, camshaft 80 turns one rotation for every two rotations of crankshaft 110. Lobe 100 presses cam follower plate 260 against pad 240, thereby moving piston 210 into hydraulic pump 40. As piston 210 moves into hydraulic pump 40, it hydraulically forces hydraulic ram 420 to open compression relief valve 190, thereby hydraulically timing and controlling relief valve 190. It will be recognized by those skilled in the art that mechanisms other than hydraulic could be utilized to time the opening of relief valve 190, such as, for exemplary purposes only, pneumatic mechanism, or electric solenoid.

The duration of opening of compression relief valve 190 is selected by the size (in degrees) of cam lobe 100. By selecting the position of cam lobe 100 on camshaft 80, compression relief valve 190 is opened at any selected stage of the engine cycle. Once such initial opening point is selected, timing of opening of compression relief valve 190 is varied by movement of pump plate 70 by concentric rotation of pump plate 70 around camshaft 80.

Theoretically, intake valve 150 closes at BDC. However, most engines take advantage of the fact that the piston doesn't move substantially relative to crankshaft rotation near BDC and the column inertia of the moving stream of incoming fuel/air helps charge the cylinder for a brief period, even after the piston has changed direction. Thus, the intake valve will often remain open past BDC.

Setting intake valve 150 to close at 70 degrees ABDC will permit fuel/air to continue to move into combustion chamber 140. Setting camshaft 80 to open compression relief valve 190 at BDC and for a 70 degree duration ABDC, results in closure of compression relief valve 190 at 70 degrees ABDC, coincident with closure of intake valve 150 with no compression release.

Thus, during a portion of the compression stroke, compression relief valve will be open while all other valves are closed. This permits fuel/air mix to be removed via compression relief valve 190 through venting ports 470, 480, wherein the fuel/air mix passes through check valves 310, 320 and return lines 330, 340 to a fuel supply device, such as carburetor/intake manifold 370.

It will be further recognized by those skilled in the art that other methods of timing the opening of relief valve, such as, for exemplary purposes only, computer/electronic control of timing or a valve in hydraulic line 60, could be utilized without departing from the spirit and scope of the instant invention.

However, unless check valves 310, 320 are utilized, raw air could be pulled through the compression relief valve into combustion chamber 140, wherein check valves 310, 320 ensure no backwards flow of air into combustion chamber 140. It will be recognized by those skilled in the art that fewer, or additional, check valves could be utilized without departing from the spirit and scope of the present invention.

By selection of the maximum compression that an engine is capable of handling, timing of compression relief valve 190 can reduce the compression when it is desired to utilize other fuels. In a preferred example, for use with ethanol, an engine is designed to have a compression ratio of 15 to 1. When it is desired-to utilized gasoline in the same engine without modification thereof, the compression must be reduced since current gasoline would normally be limited to a compression ratio of approximately 8.5 to 1. By opening relief valve 190 in a combustion chamber 140/piston 130 combination that is designed for 15 to 1, the compression is reduced to provide an effective compression ratio of 8.5 to 1 for gasoline.

Cam 90/cam lobe 100 combination, or other means such as solenoid or mechanical means to operate pump 40, are selected for an open duration of compression via hydraulic pressure to keep relief valve 190 open for 70 degrees. Selective rotation of pump plate 70 is subsequently utilized to retard opening and, subsequently, closing of compression relief valve 190 by 10 degrees, and, thus, compression relief valve 190 opens 10 degrees ABDC and closes at 80 degrees ABDC, thus closing 10 degrees after, or later, than the closing of intake valve 150. Accordingly, compression is lost during the 10 degree duration after closure of intake valve 150 until the closure of compression relief valve 190. If timing adjustment/pump support plate 70 is moved to additionally retard closing of compression relief valve 190, more compression is lost. Thus, timing of opening and closing of compression relief valve 190 can be selectively utilized to accommodate the requirements of different fuels in the same engine without modification through the use of timable hydraulic control of relief valve 190.

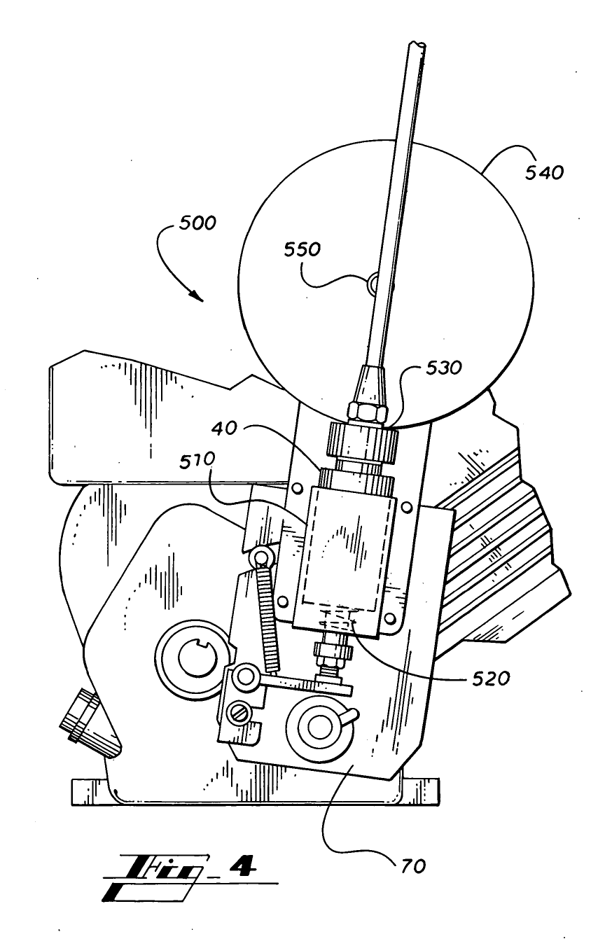

Referring now more specifically to FIG. 4, illustrated therein is an alternate embodiment of device 10, wherein the alternate embodiment of FIG. 4 is substantially equivalent in form and function to that of the preferred embodiment detailed and illustrated in FIGS. 1A-3 except as hereinafter specifically referenced. Specifically, the embodiment of FIG. 4 additionally comprises valve height adjustment mechanism 500, wherein valve height adjustment mechanism 500 permits the lift (height above valve seat 490) of compression relief valve 190 to be raised or lowered. Valve height adjustment mechanism 500 comprises pump 40, housing 510, spring 520, rest 530 and wheel 540. Pump 40 is disposed within housing 510, wherein pump 40 is mounted on spring 520. Wheel 540 is mounted off center 550, wherein rotation of wheel 540 eccentrically compresses and relieves against rest 530 to move pump 40 against or away from spring 520, thereby altering position of pad 240. By moving pad 240 away from cam follower 260, relief valve 190 will be opened to a lesser extent than if pad 240 is moved closer to cam follower 260. It will be recognized by those skilled in the art that levers or other suitable means could be utilized to selectively move pump 40 in lieu of wheel 540 and rest 530.

In control of opening of relief valve 190, it is of great importance that the appropriate opening point and height of relief valve 190 be selected and timed. Due to the increase in pressure in combustion chamber 140, late opening of relief valve 190 to too great a height could result in rapid pressure release. (The same height early in the compression stroke will have little effect since little pressure has built up.) By utilizing a low lift height for relief valve 190 when the pressure in combustion chamber 140 is high, controlled release of pressure can be accomplished.

A small amount of lift at 100 degrees (or any selected optimum point) will reduce compression slightly. If compression relief valve 190 is not opened, the maximum compression of the engine will be achieved. If compression relief valve 190 is opened, or opened higher, compression will be reduced, since more venting occurs, even though the opening point of compression relief valve remains the same. In this alternate embodiment, the timing of opening of compression relief valve 190 can also remain fixed, yet a small variation in compression can be obtained via valve height adjustment mechanism 500 via selection of the optimum point to open relief valve 190 and release pressure.

In another alternate embodiment of the present invention, the optimum, or ideal, point ABDC on the compression stroke is determined and timing adjustment/pump support plate 70 is set to close compression relief valve 190 at such optimum, such as, for exemplary purpose only, 100 degrees ABDC. From this point, compression can be varied by an additional amount via by increasing the height, or lift, of compression relief valve 190. While the preferred embodiment moves the opening and closing point of the compression relief valve, the alternate embodiment does not move the opening point once selected, but keeps the opening point and controls valve height to alter compression. So long as selection of the opening and closing points of relief valve 190 result in positive pressure within combustion chamber 140, check valves 310, 320 are not required.

It will be recognized by those skilled in the art that while the present invention discloses, for exemplary purposes only, a single cylinder engine, it is suited for internal combustion engines comprising a plurality of cylinders, without departing from the spirit and scope of the present invention. In such engines, fuel/air mix could be returned via return lines 330, 340 to an intake manifold. Accordingly, check valves 310, 320 serve to prevent fuel/air from entering combustion chamber 140 via return lines 330, 340 and ports 470, 480 during an intake stroke of a multi-cylinder engine.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

1. A variable compression engine having a rotating crankshaft and a reciprocating piston attached thereto, wherein once per revolution said crankshaft reaches an angular position corresponding to a bottom dead center position of said piston, said engine also having a compression stroke, wherein said variable compression engine comprises:
a relief valve disposed within a combustion chamber of said engine, wherein said relief valve is open during a portion of said compression stroke, wherein for each time said relief valve is opened said relief valve reaches a point of peak opening and wherein said point of peak opening is variable with respect to said angular position of said crankshaft corresponding to a bottom dead center position of said piston.

2. The variable compression engine of claim 1, further comprising a means for setting an opening point for said relief valve.

3. The variable compression engine of claim 1, further comprising a cam-operated mechanism.

4. The variable compression engine of claim 3, wherein said cam-operated mechanism is in hydraulic communication with said relief valve.

5. The variable compression engine of claim 3, wherein said cam-operated mechanism is operated by a camshaft rotating once for every two revolutions of said crankshaft.

6. The variable compression engine of claim 1, further comprising at least one check valve in fluid communication with said relief valve.

7. The variable compression engine of claim 6, wherein said at least one check valve prevents flow into said combustion chamber via said relief valve.

8. A variable compression engine having a compression stroke, wherein said variable compression engine comprises:
a relief valve disposed within a combustion chamber of said engine wherein said relieve valve is open during a portion of said compression stroke; and an intake valve, wherein said intake valve remains open for a portion of said compression stroke.

9. The variable compression engine of claim 1, further comprising an intake valve, wherein said intake valve and said relief valve are both open for a selected number of degrees of rotation of said crankshaft.

10. The variable compression engine of claim 9, wherein said relief valve closes after said intake valve closes.

11. The variable compression engine of claim 1, further comprising a means for varying the lift height of said relief valve.

12. The variable compression engine of claim 1, further comprising a means for setting a closing point of said relief valve.

13. A method of reducing the compression of an internal combustion engine, said engine having a rotating crankshaft and a reciprocating piston attached thereto, wherein once per revolution said crankshaft reaches an angular position corresponding to a bottom dead center position of said piston, said engine also having a compression stroke, said method comprising the steps of:
opening a relief valve disposed within a combustion chamber of said engine during a said compression stroke of said engine,
wherein for each time said relief valve is opened said relief valve reaches a point of peak opening, and
varying said point of peak opening with respect to said angular position of said crankshaft corresponding to a bottom dead center position of said piston.

14. The method of claim 13, wherein said step of opening a relief valve comprises the step of opening said relief valve via a cam-operated mechanism.

15. The method of claim 13, wherein said step of opening a relief valve comprises the step of selectively lifting the height of said relief valve.

16. The method of claim 13, further comprising the step of:
closing an intake valve prior to closing said relief valve.

17. A variable compression engine having a rotating crankshaft and a reciprocating piston attached thereto wherein once per revolution said crankshaft reaches an angular position corresponding to a bottom dead center position of said piston, said engine also having a compression stroke, and an intake system for feeding a fuel/air mixture into said engine, wherein said variable compression engine comprises:
an intake valve, an exhaust valve and a compression relief valve disposed within a combustion chamber of said engine,
wherein when said relief valve is opened said relief valve reaches a point of peak opening, and
wherein said point of peak opening is variable with respect to said angular position of said crankshaft corresponding to a bottom dead center position of said piston.

18. The variable compression engine of claim 17, wherein said relief valve is opened during said compression stroke.

19. The variable compression engine of claim 17, wherein said compression relief valve is disposed within a valve guide, wherein said valve guide comprises at least one opening in fluid communication with a first side of a check valve, and wherein a second side of said check valve is in fluid communication with said intake system.

20. The variable compression engine of claim 17, further comprising a means for opening said relief valve.
